(19) United States
(12) Patent Application Publication
(10) Pub. No.: US 2015/0116257 A1
(43) Pub. Date: Apr. 30, 2015

(54) CAPACITIVE TOUCH DEVICE AND SENSING METHOD THEREOF

(71) Applicant: SILICON INTEGRATED SYSTEMS CORP, Hsinchu City (TW)

(72) Inventors: Jih-Ming HSU, Hsinchu City (TW); Chin-Hua KAO, Hsinchu City (TW)

(73) Assignee: SILICON INTEGRATED SYSTEMS CORP, Hsinchu City (TW)

(21) Appl. No.: 14/068,642

(22) Filed: Oct. 31, 2013

(51) Int. Cl. G06F 3/044

(52) U.S. Cl. CPC G06F 3/044
USPC 345/174

(57) ABSTRACT

A capacitive touch device and a sensing method thereof are disclosed. The capacitive touch device includes a touch panel and a plurality of touch detection units. The touch panel includes first sensing lines and second sensing lines. The position of a touch between a last one of the first sensing lines and a first one of the second sensing lines can be calculated by the first touch detection unit, the second touch detection unit, or both. The present invention is capable of avoiding the problem that the frame rate is reduced significantly because of the data transmission between the first and second touch detection units.

### TECHNICAL FIELD OF THE INVENTION

The present invention relates to a capacitive touch device, more particularly, to a capacitive touch device and a sensing method thereof.

### BACKGROUND OF THE INVENTION

When a capacitive touch panel is applied to a large scale device, a number of sensing lines is increasing. Furthermore, requirements for accelerating sensing speed and calculating scan results are also increasing.

In an axis intersect (AI) capacitance sense technology, a coordinate of a touch is detected by a self-capacitance sensing method. However, a problem of ghost point occurs in the AI capacitance sense technology. As a result, a multi-point touch cannot be detected. In contrast, in an all-points addressable (APA) capacitance sense technology, a coordinate of a touch is usually detected by a mutual-capacitance sensing method. Accordingly, a multi-point touch can be detected in the APA capacitance sense technology.

Please refer to FIG. 1. FIG. 1 is a conventional capacitive touch device 10 by utilizing the AI capacitance sense technology. The capacitive touch 10 device comprises a touch panel 100 and a plurality of touch integrated circuits (IC) 102, 104. The touch panel comprises a plurality of sensing lines S1-S20. The touch IC 102 is electrically coupled to the sensing lines S1-S10 for scanning the sensing lines S1-S10. The touch IC 104 is electrically coupled to the sensing lines S11-S20 for sensing the sensing lines S11-S20. Please refer to FIG. 2. FIG. 2 is a schematic diagram showing that the sensing lines S8-S13 and the touch ICs 102, 104 in FIG. 1. The sensing lines S10, S11 are regarded as boundary sensing lines. In the capacitive touch device 10, the position of a touch is determined by sensing two adjacent sensing lines. For example, the sensing lines S8 and S9 are charged and discharged for acquiring two analog-to-digital (ADC) values of the sensing lines S8 and S9. Then, the position of a touch between the sensing lines S8 and S9 is determined by the ADC values of the sensing lines S8 and S9. Similarly, the position of a touch between the sensing lines S9 and S10 is determined by ADC values of the sensing lines S9 and S10. The position of a touch between the sensing lines S10 and S11 is determined by ADC values of the sensing lines S10 and S11. However, the touch IC 102 is not electrically coupled to the sensing line S11, and thus the touch IC 102 cannot acquire the ADC values of the sensing line S11. When the position of the touch (between the sensing lines S10 and S11) is determined by only the ADC values of the sensing line S10, it is incorrect or small. In order to determine the correct position, the ADC values of the sensing line S11 acquired by the touch IC 104 is transmitted to the touch IC 102, such that the touch IC 102 is capable of determining the position between the sensing lines S10 and S11 by utilizing the ADC values of the sensing lines S10 and S11. Because the ADC values of the sensing line S11 have to be transmitted to the touch IC 102, the frame rate of the touch panel 100 is reduced significantly and thus performance of the capacitive touch device 10 is worse. For all-points addressable (APA) capacitance sense technology, a row of ADC values have to be transmitted to the touch IC 102, such performance suffering will become worst as well.

Therefore, there is a need for a solution to solve the above-mentioned problem that the frame rate is reduced significantly because one of two adjacent touch ICs transmits the ADC values of one boundary sensing line to the other of the two adjacent touch ICs.

### SUMMARY OF THE INVENTION

An objective of the present invention is to provide a capacitive touch device and a sensing method thereof.

In accordance with an aspect of the present invention, the capacitive touch device comprises a touch panel and a plurality of touch detection units. The touch panel comprises a plurality of first sensing lines and a plurality of second sensing lines. The touch detection units at least comprise a first touch detection unit and a second touch detection unit. The first touch detection unit is electrically coupled to the first sensing lines. The second touch detection unit is electrically coupled to the second sensing lines. A position of a touch between a last one of the first sensing lines and a first one of the second sensing lines is calculated by the first touch detection unit according to a sensed value corresponding to a first sensing line prior to the last one of the first sensing lines and a sensed value corresponding to the last one of the first sensing lines, or is calculated by the second touch detection unit according to a sensed value corresponding to the first one of the second sensing lines and a sensed value corresponding to a second sensing line after the first one of the second sensing lines.

In accordance with another aspect of the present invention, the sensing method of the capacitive touch device of the present invention comprises: scanning a first sensing line prior to a last one of the first sensing lines for obtaining a sensed value corresponding to the first sensing line prior to the last one of the first sensing lines with the first touch detection unit; scanning the last one of the first sensing lines for obtaining a sensed value corresponding to the last one of the first sensing lines with the first touch detection unit; scanning a first one of the second sensing lines for obtaining a sensed value corresponding to the first one of the second sensing lines with the second touch detection unit; scanning a second sensing line after the first one of the second sensing lines for obtaining a sensed value corresponding to the second sensing line after the first one of the second sensing lines with the second touch detection unit; and calculating a position of a touch between the last one of the first sensing lines and the first one of the second sensing lines by the first touch detection unit according to the sensed value corresponding to the first sensing line prior to the last one of the first sensing lines and the sensed value corresponding to the last one of the first sensing lines, or calculating the position of the touch by the second touch detection unit according to the sensed value corresponding to the first one of the second sensing lines and the sensed value corresponding to the second sensing line after the first one of the second sensing lines.

The capacitive touch device and the sensing method of the capacitive touch device are capable of avoiding the problem that the frame rate is reduced significantly because of the data transmission between two adjacent touch detection units.

### BRIEF DESCRIPTION OF THE DRAWINGS

The present invention will be described in detail in conjunction with the appending drawings, in which:

FIG. 1 is a conventional capacitive touch device;

FIG. 2 is a schematic diagram showing that sensing lines S8-S13 and touch ICs 102, 104 in FIG. 1;

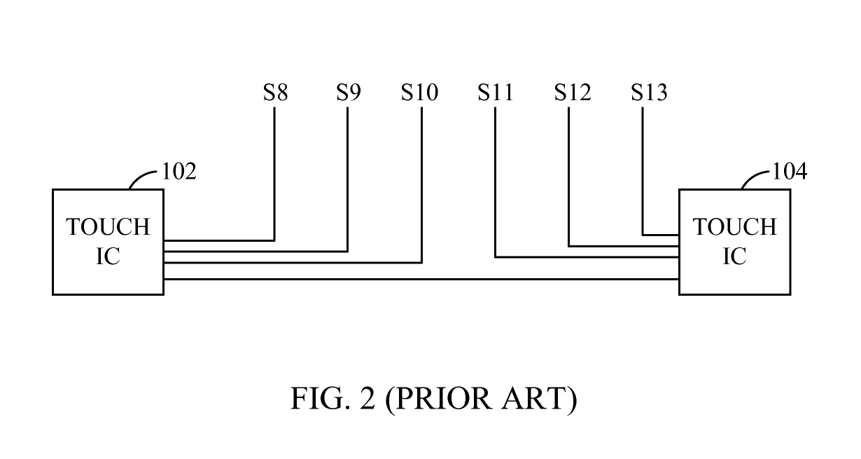

FIG. 3 is a capacitive touch device of the present invention;

FIG. 4 is a schematic diagram showing that first sensing lines RX_{I-3}-RX_{I}, second sensing lines RX_{I+1}-RX_{I+4} and touch detection units in FIG. 3 according to an embodiment of the present invention; and

FIG. 5 is a flow chart showing a sensing method of a capacitive touch device according to an embodiment of the present invention.

### DETAILED DESCRIPTION OF THE INVENTION

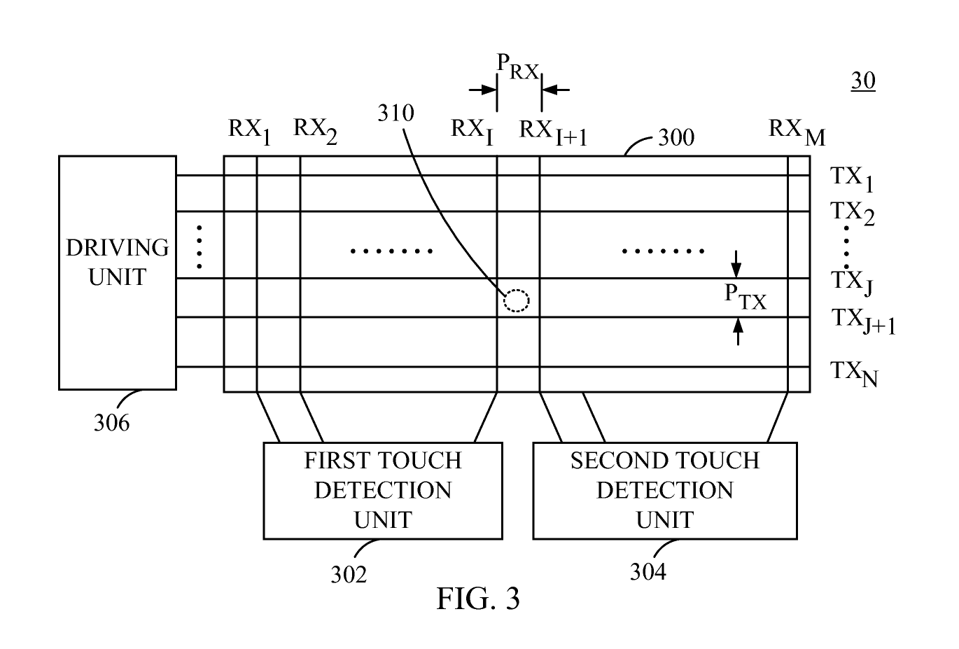

FIG. 3 is a capacitive touch device 30 of the present invention. The capacitive touch device comprises a touch panel 300, a plurality of touch detection units comprising a first touch detection unit 302 and a second touch detection unit 304, and at least one driving unit 306. The touch panel 300 comprises a plurality of first sensing lines RX₁-RX_{I}, a plurality of second sensing lines RX_{I+1}-RX_{M}, and a plurality of driving lines TX₁-TX_{N}. The first sensing lines RX₁-RX_{I} and the second sensing lines RX_{I+1}-RX_{M} are arranged in a column direction. The driving lines TX₁-TX_{N} are arranged crossing over the first and second sensing lines RX₁-RX_{M} in a row direction. The column direction is perpendicular to the row direction. I, J, M and N are positive integers. The first touch detection unit 302 is electrically coupled to the first sensing lines RX₁-RX_{I} for scanning the sensing lines RX₁-RX_{I}. The second touch detection unit 304 is electrically coupled to the second sensing lines RX_{I+1}-RX_{M} for scanning the sensing lines RX_{I+1}-RX_{M}. The first sensing line RX_{I} and the second sensing line RX_{I+1} are boundary sensing lines. The driving unit 306 is electrically coupled to the driving lines TX₁-TX_{N} for sequentially driving the driving lines TX₁-TX_{N}. A position (i.e. a coordinate) of a touch 310 between the last one (i.e. the first sensing line RX_{I}) of the first sensing lines RX₁-RX_{I} and the first one (i.e. the second sensing line RX_{I+1}) of the second sensing lines RX_{I+1}-RX_{M} is calculated by a sensed value corresponding to the first sensing line RX_{I-1} prior to the last one (i.e. the first sensing line RX_{I}) of the first sensing lines RX₁-RX_{I} and a sensed value corresponding to the last one (i.e. the first sensing line RX_{I}) of the first sensing lines RX₁-RX_{I} by utilizing an extrapolation method. This will be described in detail later.

Before the touch 310 is detected, an initial data matrix is required to be stored in advance. The initial data matrix contains sensed values scanned by the driving lines TX₁-TX_{N}, the first sensing lines RX₁-RX_{I} and the second sensing lines RX_{I+1}-RX_{M} when there is no touch. More particularly, the driving unit 306 provides a driving signal for the driving line TX₁, and the first and second touch detection units 302, 304 respectively scan the first and second sensing lines RX₁-RX_{M} for acquiring the sensed values when there is no touch. Then, the driving unit 306 provides the driving signal for the driving line TX₂, and the first and second touch detection units 302, 304 respectively scan the first and second sensing lines RX₁-RX_{M} for acquiring the sensed values when there is no touch. In the same manner, the driving lines TX₃-TX_{N} are sequentially driven by the driving unit 306, and the first and second touch detection units 302, 304 respectively scan the first and second sensing lines RX₁-RX_{M} for acquiring the sensed values when there is no touch. After all of the driving lines TX₁-TX_{N} and all of the first and second sensing lines RX₁-RX_{M} are scanned, the initial data matrix is obtained and stored.

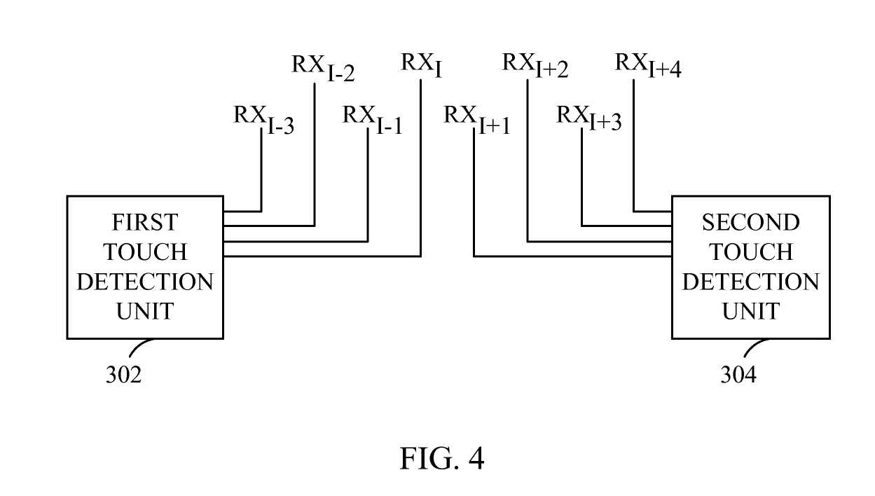

Please refer to FIG. 3 and FIG. 4. FIG. 4 is a schematic diagram showing that the first sensing lines RX_{I-3}-RX_{I}, the second sensing lines RX_{I+1}-RX_{I+4} and the first and second touch detection units 302, 304 in FIG. 3 according to an embodiment of the present invention. When the touch 310 occurs as shown in FIG. 3, the driving lines TX₁-TX_{N} are sequentially driven by the driving unit 306 and sensed values of the first and second sensing lines RX₁-RX_{M} are sensed by the first and second sensing units 302, 304 in the same manner as the steps for obtaining the initial data matrix. After all of the driving lines TX₁-TX_{N} are sequentially driven and the first and second sensing lines RX₁-RX_{M} are scanned, a current data matrix is obtained. The current data matrix contains the sensed values scanned by the first and second touch detection units 302, 304 when the touch 310 occurs. Then, a data difference matrix containing a plurality of difference values can be obtained by comparing the initial data matrix (there is no touch) with the current data matrix (the touch 310 occurs). The touch 310 can be detected according to the data difference matrix. More particularly, when one difference value in the difference value matrix is greater than a predetermined threshold value, a touch corresponding to said one difference value greater than the predetermined threshold value is detected.

After the touch 310 is detected, the capacitive touch device 30 of the present invention provides an extrapolation method to determine a position (i.e. a coordinate) of the touch 310. Assuming that the touch 310 is positioned between the first sensing line RX_{I} and the second sensing line RX_{I+1} and between the driving line TX_{J} and the driving line TX_{J+1}, the position (POS_RX, POS_TX) of the touch 310 can be calculated as follows. POS_RX is calculated according to the following equation (1) by utilizing an interpolation method:

$$POS\_RX = \frac{\begin{matrix}( {POS}_{I - 1} \times {DIFF}_{( I - 1 , J )} ) + ( {POS}_{I} \times {DIFF}_{( I , J )} ) + \\ ( {POS}_{I + 1} \times {DIFF}_{( I + 1 , J )} ) +\end{matrix}}{( {DIFF}_{( I - 1 , J )} + {DIFF}_{( I + J )} + {DIFF}_{( I + 1 , J )} )} \qquad ( 1 )$$

POS_{I-1} is the position of the first sensing line RX_{I-1}. DIFF_{(I-1, J)} is a difference value corresponding to the first sensing line RX_{I-1} and the driving line TX_{J}. POS_{I} is the position of the first sensing line RX_{I}. DIFF_{(I, J)} is a difference value corresponding to the first sensing line RX_{I} and the driving line TX_{J}. POS_{I+1} is a position of the second sensing line RX_{I+1}. DIFF_{(I+1, J)} is a difference value corresponding to the second sensing line RX_{I+1} and the driving line TX_{J}. Specifically, DIFF_{(I-1, J)}, DIFF_{(I, J)} and DIFF_{(I+1, J)} are the difference values between the sensed value when the touch 310 occurs and the sensed value when there is no touch. Since a pitch P between any two adjacent sensing lines is the same, the equation (1) is rewritten as the following equation (2):

$$\begin{matrix}POS\_RX = \frac{\begin{matrix}\begin{matrix}[ ( {POS}_{I} - {P}_{RX} ) \times {DIFF}_{( I - 1 , J )} ] + \\ {POS}_{I} \times {DIFF}_{( I , J )} +\end{matrix} \\ [ ( {POS}_{I} + {P}_{RX} ) \times {DIFF}_{( I + 1 , J )} ]\end{matrix}}{( {DIFF}_{( I - 1 , J )} + {DIFF}_{( I , J )} + {DIFF}_{( I + 1 , J )} )} \\ = \frac{\begin{matrix}{POS}_{I} \times ( {DIFF}_{( I - 1 , J )} + {DIFF}_{( I , J )} + {DIFF}_{( I + 1 , J )} ) + \\ {P}_{RX} \times ( {DIFF}_{( I + 1 , J )} - {DIFF}_{( I - 1 , J )} )\end{matrix}}{( {DIFF}_{( I - 1 , J )} + {DIFF}_{( I , J )} + {DIFF}_{( I + 1 , J )} )} \\ = {POS}_{I} + \frac{{P}_{RX} \times ( {DIFF}_{( I + 1 , J )} - {DIFF}_{( I - 1 , J )} )}{( {DIFF}_{( I - 1 , J )} + {DIFF}_{( I , J )} + {DIFF}_{( I + 1 , J )} )}\end{matrix} \qquad ( 2 )$$

Furthermore, the difference value DIFFₐₘ corresponding to the first sensing line RX_{I} (the middle sensing line among the first sensing line RX_{I-1}, the first sensing line RX_{I} and the second sensing line RX_{I+1}) and the driving line TX_{J} can be multiplied by a weighting factor W_{RX} for adjusting influence of the difference value DIFF_{(I,J)}, so as to improve accuracy of POS_RX. The weighting factor W_{RX} is ranged from 0 to 1. Accordingly, the equation (2) is rewritten as the following equation (3):

$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {W}_{RX} \times {DIFF}_{( I , J )} + {DIFF}_{( I + 1 , J )} )} \qquad ( 3 )$$

As mentioned above, POS_RX is calculated with the equations (2) or (3) by utilizing the interpolation method. However, the first touch detection unit 302 is not electrically coupled to the second sensing line RX_{I+1}, and thus the first touch detection unit 302 cannot obtain the difference value DIFF_{(I+1, J)}. The present invention utilizes the extrapolation method to estimate the difference value DIFF_{(I+1, J)}. The difference value DIFF_{(I+1, J)} is calculated according to the following equation (4):

DIFF_{(l+1, J)}=W_{(l+1, J)}×[0,(DIFF_{(l, J)}−DIFF_{(l—1, J)})] (4)

Specifically, the difference value DIFF_{(I+1, J)} is equal to zero or [W_{(I+1, J)}×(DIFF_{(I, J)}−DIFF_{(I-1, J)})]. Since the difference value DIFF_{(I, J)} must be greater than the difference value DIFF_{(I+1, J)} and the difference value DIFF_{(I-1, J)}, the difference value DIFF_{(I+1, J)} is zero or a positive value. It can be understood from the equation (4) that the difference value DIFF_{(I+1, J)} is estimated based on the difference values DIFF_{(I-1, J)} and DIFF_{(I, J)}. That is, the difference value DIFF_{(I+1, J)} corresponding to the first sensing line RX_{I+1} and the driving line TX_{J} is estimated based on the difference value DIFF_{(I-1, J)} corresponding to the first sensing line RX_{I-1} and the driving line TX_{J} and the difference value DIFF_{(I, J)} corresponding to the first sensing line RX_{I} and the driving line TX_{J}. W_{(I+1, J)} is a weighting factor for adjusting accuracy of the boundary sensing lines (i.e. RX_{I} and RX_{I+1}) and is optional. W_{(I+1, J)} is ranged from 0 to 1. In a general case, W_{(I+1, J)} is one.

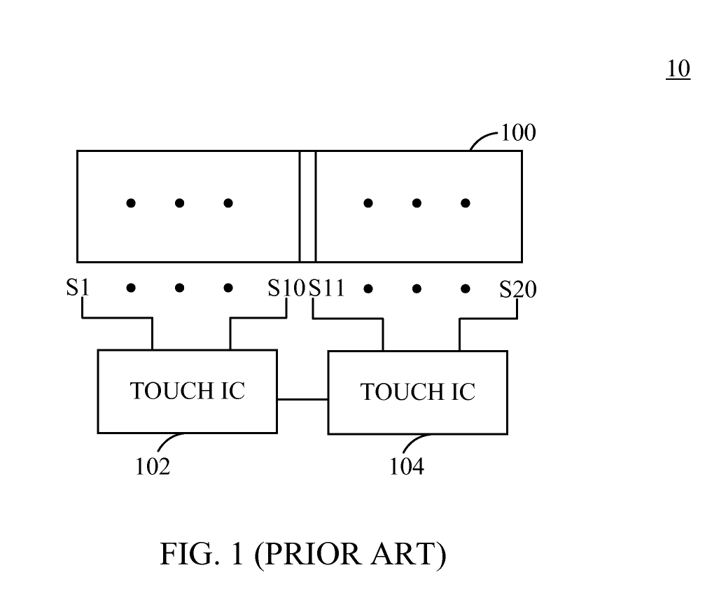

In the prior arts, the first touch detection unit 302 is not electrically coupled to the second sensing line RX_{I+1} (referring to FIG. 1), and thus the difference value DIFF_{(I+1, J)} cannot be sensed by the first touch detection unit 302. Accordingly, the second touch detection unit 304 has to transmit the difference value DIFF_{(I+1, J)} (or the sensed value corresponding to the second sensing line RX_{I+1} and the driving line TX_{J}) to the first touch detection unit 302, such that the first touch detection unit 302 can calculate POS_RX of the touch 310. Transmission and synchronization between the first and second touch detection units 302 and 304 cause the frame rate of the touch panel 300 to be reduced significantly. In the capacitive touch device 30 of the present invention, although the first touch detection unit 302 is not electrically coupled to the second sensing line RX_{I+1}, the difference value DIFF_{(I+1,J)} can be estimated by the difference value DIFF_{(I, J)} corresponding to the first sensing line RX_{I} and the driving line TX_{J} and the difference value DIFF_{(I-1, J)} corresponding to the first sensing line RX_{I-1} and the driving line TX_{J}. As a result, the transmission and synchronization between the first and second touch detection units 302 and 304 are not required, and the problem that the frame rate of the touch panel 300 is reduced significantly can be avoided.

In the same manner, POS_TX can be calculated according to the following equation (5) with the interpolation method:

$$POS\_TX = {POS}_{J} + \frac{{P}_{TX} \times ( {DIFF}_{( I , J + 1 )} - {DIFF}_{( I , J - 1 )} )}{( {DIFF}_{( I , J - 1 )} + {DIFF}_{( I , J )} + {DIFF}_{( I , J + 1 )}} \qquad ( 5 )$$

POS_{J} is the position of the driving line TX_{J}. DIFF_{(I, J-1)} is a difference value corresponding to the first sensing line RX_{I} and the driving line TX_{J-1}. DIFF_{(I, J)} is the difference value corresponding to the first sensing line RX_{I} and the driving line TX_{J}. DIFF_{(I, J+1)} is a difference value corresponding to the first sensing line RX_{I} and the driving line TX_{J+1}. P_{TX} is a pitch between any two adjacent driving lines.

Furthermore, the difference value DIFF_{(I,J)} corresponding to the first sensing line RX_{I} and the driving line TX_{J} (the middle driving line among the driving line TX_{J-1}, the driving line TX_{J} and the driving line TX_{J+1}) can be multiplied by a weighting factor W_{TX} for adjusting influence of the difference value DIFF_{(I,J)}, so as to improve accuracy of POS_TX. Accordingly, the equation (5) is rewritten as the following equation (6):

$$POS\_TX = {POS}_{J} + \frac{{P}_{TX} \times ( {DIFF}_{( I , J + 1 )} - {DIFF}_{( I , J - 1 )} )}{( {DIFF}_{( I , J - 1 )} + {W}_{TX} \times {DIFF}_{( I , J )} + {DIFF}_{( I , J + 1 )} )} \qquad ( 6 )$$

It is noted that the extrapolation method in the above-mentioned equation (4) is suitable for the touch detection unit 302. In another embodiment, the extrapolation method is suitable for the touch detection unit 304 as well. Specifically, the difference value DIFF_{(I, J)} corresponding to the first sensing line RX_{I} and the driving line TX_{J} is estimated based on the difference value DIFF_{(I+1, J)} corresponding to the second sensing line RX_{I+1} and the driving line TX_{J} and the difference value DIFF_{(I+2, J)} corresponding to the second sensing line RX_{I+2} and the driving line TX_{J} by the second touch detection unit 302. The touch 310 can be detected by the first touch detection unit 302 or the second touch detection unit 304. The detected results of the first and second touch detection units 302, 304 can be merged as one touch. Any one of calculation results of the first and second touch detection units 302, 304 can be served as the position (POS_RX, POS_TX) of the touch 310. Alternatively, an average of the calculation results of the first and second touch detection units 302, 304 can be served as the position (POS_RX, POS_TX) of the touch 310.

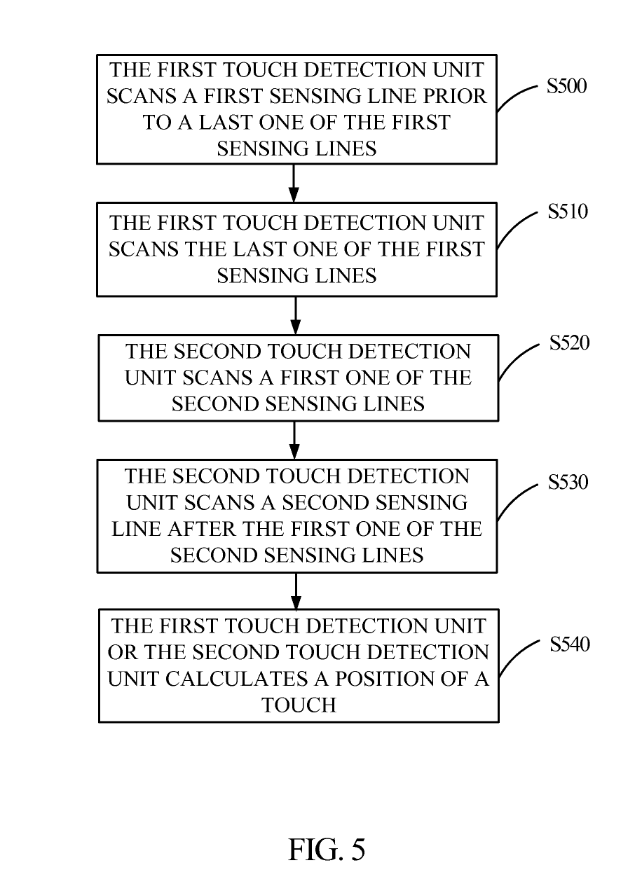

Please refer to FIG. 5. FIG. 5 is a flow chart showing a sensing method of a capacitive touch device according to an embodiment of the present invention.

The capacitive touch device comprises a touch panel and a plurality of touch detection units. The touch panel comprises a plurality of first sensing lines and a plurality of second sensing lines. The touch detection units at least comprise a first touch detection unit electrically coupled to the first sensing lines and a second touch detection unit electrically coupled to the second sensing lines. The sensing method of the capacitive touch device of the present invention comprises the following steps.

In step S500, the first touch detection unit scans a first sensing line prior to a last one of the first sensing lines for obtaining a sensed value corresponding to the first sensing line prior to the last one of the first sensing lines.

In step S510, the first touch detection unit scans the last one of the first sensing lines for obtaining a sensed value corresponding to the last one of the first sensing lines.

In step S520, the second touch detection unit scans a first one of the second sensing lines for obtaining a sensed value corresponding to the first one of the second sensing lines.

In step S530, the second touch detection unit scans a second sensing line after the first one of the second sensing lines for obtaining a sensed value corresponding to the second sensing line after the first one of the second sensing lines.

In step S540, the first touch detection unit calculates a position of a touch between the last one of the first sensing lines and the first one of the second sensing lines according to the sensed value corresponding to the first sensing line prior to the last one of the first sensing lines and the sensed value corresponding to the last one of the first sensing lines. Alternatively, the second touch detection unit calculates the position of the touch according to the sensed value corresponding to the first one of the second sensing line and the sensed value corresponding to the second sensing line after the first one of the second sensing lines.

The position POS_RX of the touch is calculated according to the following equation (7):

$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {DIFF}_{( I , J )} + {DIFF}_{( I , + 1 , J )} )} \qquad ( 7 )$$

POS_{I} is the position of the last one of the first sensing line. DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch. DIFF_{(I, J)} is a difference value between the sensed value corresponding to the last one of the first sensing lines when the touch occurs and a sensed value corresponding to the last one of the first sensing lines when there is no touch. P_{RX} is a pitch between two adjacent first sensing lines. The difference value DIFF_{(I,J)} corresponding to the first sensing line RX_{I} (the middle sensing line among the first sensing line prior to the last one of the first sensing lines, the last one of the first sensing lines and the first one of the second sensing lines) and the driving line TX_{J} can be multiplied by a weighting factor W_{RX} for adjusting influence of the difference value DIFF_{(I,J)}, so as to improve accuracy of POS_RX (as shown in equation (3)).

The difference value DIFF_{(I+1, J)} is obtained by the following equation (8):

DIFF_{(l+1, J)}=[0,(DIFF_{(l, J)}−DIFF_{(l-l, J)}] (8)

The difference value DIFF_{(I+1, J)} is equal to zero or [(DIFF_{(I, J)}−DIFF_{(I-1, J)})]. Furthermore, a weighting factor W_{(I+1, J)} can be utilized for adjusting accuracy of the boundary sensing lines (i.e. RX_{I} and RX_{I+1}), as shown in the equation (4). W_{(I+1, J)} is ranged from 0 to 1. In a general case, W_{(I+1, J)} is one.

The capacitive touch device and the sensing method of the capacitive touch device are capable of avoiding the problem that the frame rate is reduced significantly because of the data transmission between two adjacent touch detection units.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A capacitive touch device, comprising:
a touch panel comprising a plurality of first sensing lines and a plurality of second sensing lines; and
a plurality of touch detection units at least comprising a first touch detection unit and a second touch detection unit, the first touch detection unit electrically coupled to the first sensing lines and the second touch detection unit electrically coupled to the second sensing lines,
wherein a position of a touch between a last one of the first sensing lines and a first one of the second sensing lines is calculated by the first touch detection unit according to a sensed value corresponding to a first sensing line prior to the last one of the first sensing lines and a sensed value corresponding to the last one of the first sensing lines, or is calculated by the second touch detection unit according to a sensed value corresponding to the first one of the second sensing lines and a sensed value corresponding to a second sensing line after the first one of the second sensing lines.

2. The capacitive touch device of claim 1, further comprising a plurality of driving lines arranged crossing over the first sensing lines and the second sensing lines.

3. The capacitive touch device of claim 2, further comprising a driving unit electrically coupled to the driving lines for sequentially driving the driving lines.

4. The capacitive touch device of claim 1, wherein the position POS_RX of the touch is calculated according to the following equation by the first touch detection unit:
$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {DIFF}_{( I , J )} + {DIFF}_{( I , + 1 , J )} )}$$
POS_{I} is a position of the last one of the first sensing line, DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch, DIFF_{(I, J)} is a difference value between the sensed value corresponding to the last one of the first sensing lines when the touch occurs and a sensed value corresponding to the last one of the first sensing lines when there is no touch, P_{RX} is a pitch between two adjacent ones of the first sensing lines,
DIFF_{(I+1, J)} is obtained by the following equation:
DIFF_{(I+1, J)}=min[0,(DIFF_{(I, J)}−DIFF_{(I-1, J)})].

5. The capacitive touch device of claim 1, wherein the position POS_RX of the touch is calculated according to the following equation by the first touch detection unit:
$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {DIFF}_{( I , J )} + {DIFF}_{( I , + 1 , J )} )}$$
POS_{I} is a position of the last one of the first sensing line, DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch, DIFF_{(I, J)} is a difference value between the sensed value corresponding to the last one of the first sensing lines when the touch occurs and a sensed value corresponding to the last one of the first sensing lines when there is no touch, P_{RX} is a pitch between two adjacent ones of the first sensing lines,
DIFF_{(I+1, J)} is obtained by the following equation:
DIFF_{(l+1, J)}=W_{(l+1, J)}×[0,(DIFF_{(i, J)}−DIFF_{(l-1, J)})]
W_{(I+1, J)} is a weighting factor.

6. The capacitive touch device of claim 1, wherein the position POS_RX of the touch is calculated according to the following equation by the first touch detection unit:
$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {W}_{RX} \times {DIFF}_{( I , J )} + {DIFF}_{( I , + 1 , J )} )}$$
POS_{I} is a position of the last one of the first sensing line, DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch, DIFF_{(I, J)} is a difference value between the sensed value corresponding to the last one of the first sensing lines when the touch occurs and a sensed value corresponding to the last one of the first sensing lines when there is no touch, P_{RX} is a pitch between two adjacent ones of the first sensing lines, W_{RX} is a weighting factor,
DIFF_{(I+1, J)} is obtained by the following equation:
DIFF_{(l+1, J)}=[0,(DIFF_{(l, J)}−DIFF_{(l-1, J)})].

7. The capacitive touch device of claim 1, wherein the position POS_RX of the touch is calculated according to the following equation by the first touch detection unit:
$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {W}_{RX} \times {DIFF}_{( I , J )} + {DIFF}_{( I , + 1 , J )} )}$$
POS_{I} is a position of the last one of the first sensing line, DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch, DIFF_{(I, J)} is a difference value between the sensed value corresponding to the last one of the first sensing lines when the touch occurs and a sensed value corresponding to the last one of the first sensing lines when there is no touch, P_{RX} is a pitch between two adjacent ones of the first sensing lines,
DIFF_{(I+1, J)} is obtained by the following equation:
DIFF_{(l+1, J)}=W_{(l+1, J)}×[0,(DIFF_{(l, J)}−DIFF_{(l-1, J)})].
W_{RX} and W_{(I+1, J)} are weighting factors.

8. A sensing method of a capacitive touch device, the capacitive touch device comprising a touch panel and a plurality of touch detection units, the touch panel comprising a plurality of first sensing lines and a plurality of second sensing lines, the touch detection units at least comprising a first touch detection unit electrically coupled to the first sensing lines and a second touch detection unit electrically coupled to the second sensing lines, the sensing method comprising:
scanning a first sensing line prior to a last one of the first sensing lines for obtaining a sensed value corresponding to the first sensing line prior to the last one of the first sensing lines with the first touch detection unit;
scanning the last one of the first sensing lines for obtaining a sensed value corresponding to the last one of the first sensing lines with the first touch detection unit;
scanning a first one of the second sensing lines for obtaining a sensed value corresponding to the first one of the second sensing lines with the second touch detection unit;
scanning a second sensing line after the first one of the second sensing lines for obtaining a sensed value corresponding to the second sensing line after the first one of the second sensing lines with the second touch detection unit; and
calculating a position of a touch between the last one of the first sensing lines and the first one of the second sensing lines by the first touch detection unit according to the sensed value corresponding to the first sensing line prior to the last one of the first sensing lines and the sensed value corresponding to the last one of the first sensing lines, or calculating the position of the touch by the second touch detection unit according to the sensed value corresponding to the first one of the second sensing line and the sensed value corresponding to the second sensing line after the first one of the second sensing lines.

9. The sensing method of the capacitive touch device of claim 8, wherein the position POS_RX of the touch is calculated according to the following equation by the first touch detection unit:
$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {DIFF}_{( I , J )} + {DIFF}_{( I , + 1 , J )} )}$$
POS_{I} is a position of the last one of the first sensing line, DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch, DIFF_{(I, J)} is a difference value between the sensed value corresponding to the last one of the first sensing lines when the touch occurs and a sensed value corresponding to the last one of the first sensing lines when there is no touch, P_{RX} is a pitch between two adjacent ones of the first sensing lines,
DIFF_{(I+1, J)} is obtained by the following equation:
DIFF_{(l+1, J)}=[0,(DIFF_{(l, J)}−DIFF_{(l-1, J)})].

10. The sensing method of the capacitive touch device of claim 8, wherein the position POS_RX of the touch is calculated according to the following equation by the first touch detection unit:
$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {DIFF}_{( I , J )} + {DIFF}_{( I , + 1 , J )} )}$$
POS_{I} is a position of the last one of the first sensing line, DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch, DIFF_{(I, J)} is a difference value between the sensed value corresponding to the last one of the first sensing lines when the touch occurs and a sensed value corresponding to the last one of the first sensing lines when there is no touch, P_{RX} is a pitch between two adjacent ones of the first sensing lines,
DIFF_{(I+1, J)} is obtained by the following equation:
DIFF_{(l+1, J)}=W_{(l+1, J)}×[0,(DIFF_{(l, J)}−DIFF_{(l-1, J)})]
W_{(I+1, J)} is a weighting factor.

11. The sensing method of the capacitive touch device of claim 8, wherein the position POS_RX of the touch is calculated according to the following equation by the first touch detection unit:
$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {W}_{RX} \times {DIFF}_{( I , J )} + {DIFF}_{( I , + 1 , J )} )}$$
POS_{I} is a position of the last one of the first sensing line, DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch, DIFF_{(I, J)} is a difference value between the sensed value corresponding to the last one of the first sensing lines when the touch occurs and a sensed value corresponding to the last one of the first sensing lines when there is no touch, P_{RX} is a pitch between two adjacent ones of the first sensing lines, W_{RX} is a weighting factor,
DIFF_{(I+1, J)} is obtained by the following equation:
DIFF_{(l+1, J)}=[0,(DIFF_{(i, J)}−DIFF_{(l-1, J)})].

12. The sensing method of the capacitive touch device of claim 8, wherein the position POS_RX of the touch is calculated according to the following equation by the first touch detection unit:
$$POS\_RX = {POS}_{I} + \frac{{P}_{RX} \times ( {DIFF}_{( I + 1 , J )} - {DIFF}_{( I - 1 , J )} )}{( {DIFF}_{( I - 1 , J )} + {W}_{RX} \times {DIFF}_{( I , J )} + {DIFF}_{( I , + 1 , J )} )}$$
POS_{I} is a position of the last one of the first sensing line, DIFF_{(I-1, J)} is a difference value between the sensed value corresponding to the first sensing line prior to the last one of the first sensing lines when the touch occurs and a sensed value corresponding to the first sensing line prior to the last one of the first sensing lines when there is no touch, DIFF_{(I, J)} is a difference value between the sensed value corresponding to the last one of the first sensing lines when the touch occurs and a sensed value corresponding to the last one of the first sensing lines when there is no touch, P_{RX} is a pitch between two adjacent ones of the first sensing lines, W_{RX} is a weighting factor,
DIFF_{(I+1, J)} is obtained by the following equation:
DIFF_{(l+1, J)}=W_{(l+1, J)}×[0,(DIFF_{(i, J)}−DIFF_{(l-1, J)})].
W_{RX} and W_{(I+1, J)} are weighting factors.
